(19) United States
(12) Patent Application Publication
(10) Pub. No.: US 2012/0155468 A1
(43) Pub. Date: Jun. 21, 2012

(54) MULTI-PATH COMMUNICATIONS IN A DATA CENTER ENVIRONMENT

(75) Inventors: Albert Gordon Greenberg, Seattle, WA (US); Changhoon Kim, Redmond, WA (US); David A. Maltz, Bellevue, WA (US); Jitendra Dattatraya Padhye, Redmond, WA (US); Murari Sridharan, Sammamish, WA (US); Bo Tan, Champaign, IL (US)

(73) Assignee: Microsoft Corporation, Redmond, WA (US)

(21) Appl. No.: 12/973,914

(22) Filed: Dec. 21, 2010

(51) Int. Cl. H04L 12/56

(52) U.S. Cl. 370/392

(57) ABSTRACT

Various technologies related to multi-path communications in a data center environment are described herein. Network infrastructure devices communicate traffic flows amongst one another, wherein a traffic flow includes a plurality of data packets intended for a particular recipient computing device that are desirably transmitted and received in a certain sequence. Indications that data packets in the traffic flow have been received outside of the certain sequence are processed in a manner to prevent a network infrastructure device from retransmitting a particular data packet.

### BACKGROUND

A data center is a facility that is used to house computer systems and associated components for a particular enterprise. These systems and associated components include processing systems (such as servers), data storage devices, telecommunications systems, network infrastructure devices (such as switches and routers), amongst other systems/components. Oftentimes, workflows exist such that data generated at one or more computing devices in the data center must be transmitted to another computing device in the data center to accomplish a particular task. Typically, data is transmitted in data centers by way of packet-switched networks, such that traffic flows are transmitted amongst network infrastructure devices, wherein a traffic flow is a sequence of data packets that pertain to a certain task over a period of time. In some cases, the traffic flows are relatively large, such as when portions of an index used by a search engine are desirably aggregated from amongst several servers. In other cases, the traffic flow may be relatively small, but may also be associated with a relatively small amount of acceptable latency when communicated between computing devices.

A consistent theme in data center design has been to build highly available, high performance computing and storage infrastructure using low cost, commodity components. In particular, low-cost switches are common, providing up to 48 ports at 1 Gbps, at a price under $2,000. Several recent research proposals envision creating economical, easy-to-manage data centers using novel architectures built on such commodity switches. Accordingly, using these switches, multiple communications paths between computing devices (e.g., servers) in the data center often exist.

Network infrastructure devices in data centers are configured to communicate through use of the Transmission Control Protocol (TCP). TCP is a communications protocol that is configured to provide a reliable, sequential delivery of data packets from a program running on a first computing device to a program running on a second computing device. Traffic flows over networks using TCP, however, are typically limited to a single communications path (that is, a series of individual links) between computing devices, even if other links have bandwidth to transmit data. This can be problematic in the context of data centers that host search engines. For example, large flows, such as file transfers associated with portions of an index utilized by search engine (e.g., of 100 MB or greater) can interfere with latency-sensitive small flows, such as query traffic.

### SUMMARY

The following is a brief summary of subject matter that is described in greater detail herein. This summary is not intended to be limiting as to the scope of the claims.

Described herein are various technologies pertaining to communications between computing devices in data center network. More specifically, described herein are various technologies that facilitate multi-path communications between computing devices in a data center network. A data center as described herein can include multiple computing devices, which may comprise servers, routers, switches, and other devices that are typically associated with data centers. Servers may be commissioned in the data center to execute programs that perform various computational tasks. Pursuant to a particular example, the servers in the data center may be commissioned to maintain an index utilized by a search engine, can be commissioned to search over the index subsequent to receipt of a user query, amongst other information retrieval tasks. It is to be understood, however, that computing devices in the data center may be commissioned for any suitable purpose.

A network infrastructure apparatus, which may be a switch, a router, a combination switch/router, or the like may receive a traffic flow from a sender computing device that is desirably transmitted to a recipient computing device. The traffic flow includes multiple data packets that are desirably received by the recipient computing device in a particular sequence. For instance, the recipient computing device may be configured to send and receive communications in accordance with the Transmission Control Protocol (TCP). The topology of the data center network may be configured such that multiple communications paths/links exist between the sender computing device and the recipient computing device. The network infrastructure apparatus can cause the traffic flow to be spread across the multiple communications links, such that network resources are pooled when traffic flows are transmitted between sender computing devices and receiver computing devices. Specifically, a first data packet in the traffic flow can be transmitted to the recipient computing device across a first communications link while a second data packet in the traffic flow can be transmitted to the recipient computing device across a second communications link.

In accordance with an aspect described herein, the network infrastructure device and/or the sender computing device can be configured to add entropy to each data packet in the traffic flow. Conventionally, network switches spread traffic across links based upon contents in the header of the data packet, such that network traffic from a particular sender to a specified receiver in the headers of data packets are transmitted across a single communications channel. The infrastructure device can be configured to alter insignificant portions of the address of the recipient computing device (retained in an address field in the header) in the data center network, thereby causing the network infrastructure device to spread data packets in a traffic flow across multiple communications links. A recipient switch can include a hashing algorithm or other suitable algorithm that removes the entropy, such that the recipient computing device receives the data packets in the traffic flow.

Additionally, the infrastructure apparatus can be configured to recognize indications from the recipient computing device that one or more data packets in the traffic flow have been received out of a desired sequence. For instance, a sender computing device and a receiver computing device can be configured to communicate by way of TCP, wherein the receiver computing device transmits duplicate acknowledgments if, for instance, a first packet desirably received first in a sequence is received first, a second packet desirably received second in the sequence is not received, and a third packet desirably received third in the sequence is received prior to the packet desirably received second. In such a case, a duplicate acknowledgment is transmitted by the recipient computing device to the sender computing device indicating that the first packet has been received (thereby initiating transmittal of the second packet). The sender computing device can process the duplicate acknowledgment in such a manner as to prevent the sender computing device from retransmitting the second packet. The non-sequential receipt of data packets in a traffic flow can occur due to data packets in the traffic flow being transmitted over different communications paths that may have differing latencies corresponding thereto.

The processing performed by the sender computing device can include ignoring the duplicate acknowledgment, waiting until a number of duplicate acknowledgments with respect to a data packet reach a particular threshold (higher than a threshold corresponding to TCP), or treating the duplicate acknowledgment as a regular acknowledgment.

Other aspects will be appreciated upon reading and understanding the attached figures and description.

### BRIEF DESCRIPTION OF THE DRAWINGS

FIG. 1 is a functional block diagram of an exemplary system that facilitates a sender computing device in a data center transmitting a traffic flow to a recipient computing device in the data center over multiple paths.

FIG. 2 is a functional block diagram of an exemplary system that facilitates transmitting traffic flows between sender computing devices and recipient computing devices over multiple communications paths.

FIG. 3 is a high level exemplary implementation of aspects described herein.

FIG. 4 is an exemplary network/computing topology in a data center.

FIG. 5 is a flow diagram that illustrates an exemplary methodology for processing indications that data packets are received in an undesirable sequence in a data center that supports multi-path communications.

FIG. 6 is a flow diagram that illustrates an exemplary methodology for transmitting a traffic flow over multiple communications paths in a data center network by adding entropy to data packets in the traffic flow.

FIG. 7 is an exemplary computing system.

### DETAILED DESCRIPTION

Various technologies pertaining to multi-path communications in a data center environment will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

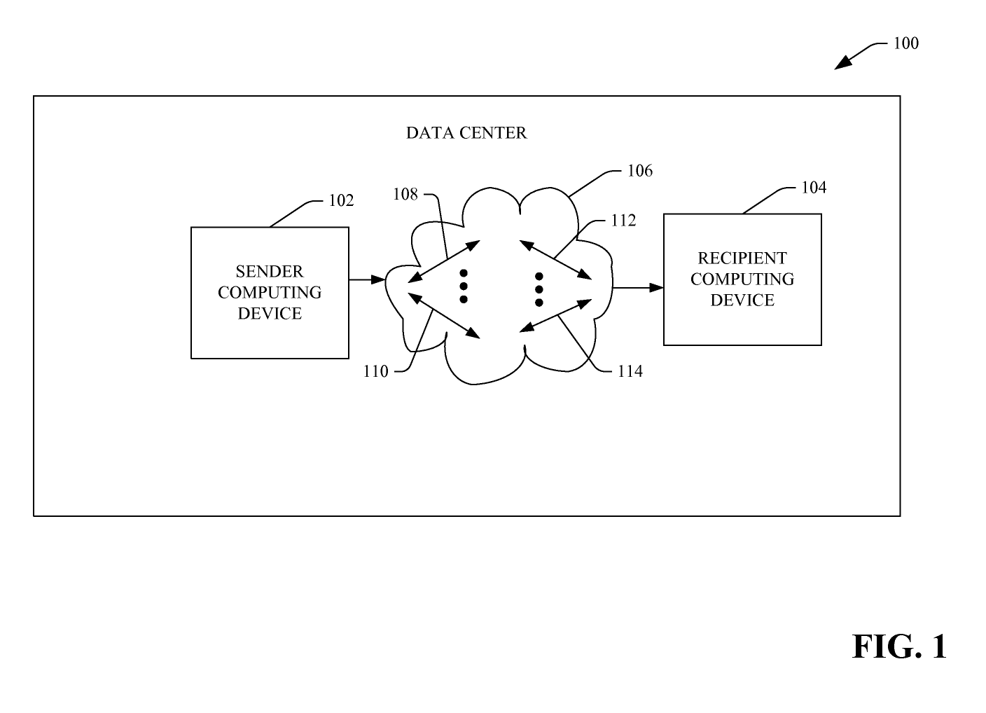

With reference to FIG. 1, an exemplary data center 100 is illustrated, wherein computing devices communicate over a data center network that supports multi-path communications. That data center 100 comprises multiple computing devices that can work in conjunction to perform computational tasks for a particular enterprise. In an exemplary embodiment, at least a portion of the data center 100 can be configured to perform computational tasks related to search engines, including building and maintaining an index of documents available on the World Wide Web, searching the index subsequent to receipt of a query, outputting a web page that corresponds to the query, etc. Thus, the data center 100 can include multiple computing devices (such as servers or other processing devices) and network infrastructure devices that allow these computing devices to communicate with one another (such as switches, routers, repeaters) as well as transmission mediums for transmitting data between network infrastructure devices and/or computing devices.

As indicated above, oftentimes an application executing on one computing device may desire to transmit data to an application executing on another computing device across the data center network. In data center networks, due to a plurality of routers, switches, and other network infrastructure devices, multiple communications paths may exist between any two computing devices. The data center 100 comprises computing devices and/or network infrastructure devices that facilitate multi-path communication of traffic flows between computing devices therein.

With more specificity, the data center 100 includes a sender computing device 102, which may be a server that is hosting a first application that is configured to perform a particular computational task. The data center 100 further comprises a recipient computing device 104, wherein the recipient computing device 104 hosts a second application that consumes data processed by the first application. In accordance with an aspect described herein, the sender computing device 102 and the recipient computing device 104 can be configured to communicate with one another through utilization of the Transmission Control Protocol (TCP). Thus, the sender computing device 102 may desirably transmit a traffic flow to the recipient computing device 104, wherein the traffic flow comprises multiple data packets, and wherein the multiple data packets are desirably transmitted by the sender computing device 102 and received by the recipient computing device 104 in a particular sequence.

The data center 100 can further include a network 106 over which the sender computing device 102 and the recipient computing device 104 communicate. As indicated above, the network 106 can comprise a plurality of network infrastructure devices, including routers, switches, repeaters, and the like. The network 106 can be configured such that multiple communications paths 108-114 exist between the sender computing device 102 and the recipient computing device 104. As will be shown and described in greater detail below, the network 106 can be configured to allow the sender computing device 102 to transmit a single traffic flow to the recipient computing device 104 over multiple communication links/paths, such that two different data packets in the traffic flow are transmitted from the sender computing device 102 to the recipient computing device 104 over two different communications paths. Accordingly, the data center 100 is configured for multi-path communications between computing devices.

Allowing for multi-path communications in the data center 100 is a non-trivial proposition. As indicated above, the computing devices in the data center can be configured to communicate by way of TCP (or other suitable protocol where a certain sequence of packets in a traffic flow is desirable). As different communications paths between computing devices in the data center 100 may have differing latencies and/or bandwidth, a possibility exists that data packets in a traffic flow will arrive outside of a desired sequence at the intended recipient computing device. Proposed approaches for multi-path communications in Wide Area Networks (WANs) involve significantly modifying the TCP standard, and may be impractical in real-world applications. The approach for multi-path communications in data centers described herein largely leaves the TCP standard unchanged without significantly affecting reliability of data transmittal in the network. This is at least partially due to factors that pertain to data centers but do not hold true for WANs.

For instance, conditions in the data center 100 are relatively homogenous, such that each communications path in the data center network 106 has relatively similar bottleneck capacity and delay. Further, in some implementations, traffic flows in the data center 100 can utilize a substantially similar congestion flow policy, such as DCTCP, which has been described in U.S. patent application Ser. No. 12/714,266, filed on Feb. 26, 2010, and entitled “COMMUNICATION TRANSPORT OPTIMIZED FOR DATA CENTER ENVIRONMENT”, the entirety of which is incorporated herein by reference. In addition, each router and/or switch in the data center 100 can support ECMP per packet round-robin or similar protocol that supports equal splitting of data packets across communication paths. This homogeneity is possible, as a single entity is often has control over each device in the data center 100. Given such homogeneity, multi-path routing of a traffic flow from the sender computing device 102 to the recipient computing device 104 can be realized.

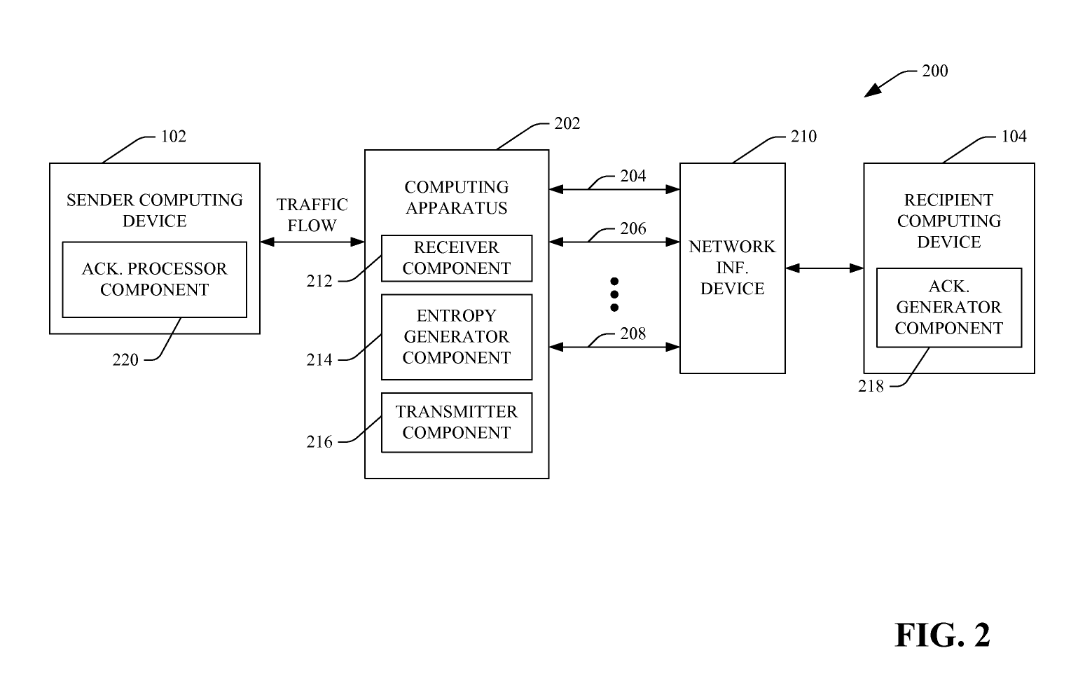

With reference now to FIG. 2, an exemplary system 200 that facilitates multi-path transmission of a traffic flow between the sender computing device 102 and the recipient computing device 104 is illustrated. A computing apparatus 202 is in communication with the sender computing device 102, wherein the computing apparatus 202 may be a network infrastructure device such as a switch, a router, or the like. The computing apparatus 202 can be in communication with a plurality of other network infrastructure devices, such that the computing apparatus 202 can transmit data packets over a plurality of communications paths 204-208. A network infrastructure device 210, such as a switch or router, can receive data packets over the plurality of communication paths 204-208. The recipient computing device 104 is in communication with the network infrastructure device 210, such that data packets received over the multiple communication paths 204-208 by the network infrastructure device 210 can be directed to the recipient computing device 104 by the network infrastructure device 210. Thus, multiple communications paths exist between the sender computing device 102 and the recipient computing device 104.

As described above, the sender computing device 102 includes the first application that outputs data that is desirably received by the second application executing on the recipient computing device 104. The sender computing device 102 can transmit data in accordance with a particular packet-switched network protocol, such as TCP or other suitable protocol. Thus, the sender computing device 102 can output a traffic flow, wherein the traffic flow comprises a plurality of data packets that are arranged in a particular sequence. The data packets can each include a header, wherein the header comprises an address of the recipient computing device 104 as well as data that indicates a position of the respective data packet in the particular sequence of data packets in the traffic flow. The sender computing device 102 can output the aforementioned traffic flow, and the computing apparatus 202 can receive the traffic flow.

The computing apparatus 202 comprises a receiver component 212 that receives the traffic flow from the sender computing device 102. For instance, the receiver component 212 can be or include a transmission buffer. The computing apparatus 202 further comprises an entropy generator component 214 that adds some form of entropy to data in the header of each data packet in the traffic flow. For example, the computing apparatus 202 may generally be configured to transmit data in accordance with TCP, such that the computing apparatus 202 attempts to transmit the entirety of a traffic flow over a single communications path. Typically, this is accomplished by analyzing headers of data packets and transmitting each data packet from a particular sender computing device to a single address over a same communications path. Accordingly, the entropy generator component 214 can be configured to add entropy to the address of the recipient computing device 104, such that computing apparatus 202 transmits data packets in a traffic flow over multiple communication paths. In an example, the entropy can be added to insignificant bits in the address data in the header of each data packet (e.g., the last two digits in the address).

A transmitter component 216 in the computing apparatus 202 can transmit the data packets in the traffic flow across the multiple communication paths 204-208. For instance, the transmitter component 214 can utilize ECMP per packet round-robin or similar protocol that supports equal splitting of data packets across communication paths.

The network infrastructure device 210 receives the data packets in the traffic flow over the multiple communications paths 204-208. The network infrastructure device 210 then directs the data packets in the traffic flow to the recipient computing device 104. As described above, the recipient computing device 104 communicates by way of a protocol (e.g., TCP) where the data packets in the traffic flow desirably arrive in the particular sequence. It can be ascertained, however, that the communications paths 204-208 may have differing latencies and/or a link may fail, thereby causing data packets in the traffic flow to be received outside of the desired sequence. In one exemplary embodiment, either the network infrastructure device 210 or the recipient computing device 104 can be configured with a buffer that buffers a plurality of data packets and properly orders data packets in the traffic flow as such packets are received. Once placed in the proper sequence, the data packets can be processed by the second application in the recipient computing device 104.

It may be undesirable, however, to maintain such a buffer. Accordingly, the recipient computing device 104 can comprise an acknowledgment generator component 218. The acknowledgment generator component 218 may operate in accordance with the TCP standard. For example, the acknowledgment generator component 218 can be configured to output an acknowledgment upon receipt of a particular data packet. Furthermore, the acknowledgment generator component 218 can be configured to output duplicate acknowledgments if packets are received outside of the desired sequence. In a specific example, the desired sequence may be as follows: packet 1; packet 2; packet 3; packet 4. In a conventional implementation where the traffic flow is transmitted over a single communications path, packets are typically transmitted and received in the proper sequence. Due to differing latencies over the communications paths 204-208, however, the recipient computing device 104 may receive such packets outside of the proper sequence.

For instance, the recipient computing device may first receive the first data packet, and the acknowledgment generator component can output an acknowledgment to the sender computing device 102 that the first data packet has been received, thereby informing the sender computing device 102 that the recipient computing device 104 is ready to receive the second data packet. The recipient computing device 104 may then receive the third data packet. The acknowledgment generator component 218 can recognize that the third data packet has been received out of sequence, and can generate and transmit an acknowledgment that the recipient computing device 104 has received the first data packet, thereby again informing the sender computing device 102 that the recipient computing device 104 is ready to receive the second data packet. This acknowledgment can be referred to as a duplicate acknowledgment, as it is substantially similar to the initial acknowledgment that the first data packet was received. Continuing with this example, the recipient computing device 104 may then receive the fourth data packet. The acknowledgment generator component 218 can recognize that the fourth data packet has been received out of sequence (e.g., the second data packet has not been received), and can generate and transit another acknowledgment that the recipient computing device 104 has received the first data packet and is ready to receive the second data packet.

These acknowledgments can be transmitted back to the sender computing device 102. The sender computing device 102 comprises an acknowledgment processor component 220 that processes the duplicate acknowledgments generated by the acknowledgment generator component 218 in a manner that prevents the sender computing device 102 from retransmitting data packets to the recipient computing device 104.

In a first example, the acknowledgement processor component 220 can receive a duplicate acknowledgment, recognize the duplicate acknowledgment, and discard the duplicate acknowledgment upon recognizing the duplicate acknowledgment. Using this approach, for instance, software can be configured as an overlay to TCP, such that the standard for TCP need not be modified to effectuate multipath communications. Such approach by the acknowledgement processor component 220 may be practical in data center networks, as communications are generally reliable and dropped data packets and/or link failure is rare.

In a second example, the acknowledgment processor component 220 can receive a duplicate acknowledgment, recognize the duplicate acknowledgment, and treat the duplicate acknowledgment as an initial acknowledgment. Thus, the sender computing device 102 can respond to the duplicate acknowledgment. Using this approach, data can be extracted from the duplicate acknowledgment that pertains to network conditions. This type of treatment of duplicate acknowledgments, however, may fall outside of TCP standards. In other words, one or more computing devices in the data center may require alteration outside of the TCP standard to treat duplicate acknowledgments in this fashion. Accordingly, this approach is practical for situations where a single entity has ownership/control over each computing device (including network infrastructure device) in the data center.

In a third example, the acknowledgment processor component 220 can be configured to count a number of duplicate acknowledgments received with respect to a certain data packet and compare the number with a threshold, wherein the threshold is greater than three. If the number of duplicate acknowledgments is below the threshold, then the acknowledgment processor component 220 prevents the sender computing device 102 from retransmitting a data packet. If the number of duplicate acknowledgments is equal to or greater than the threshold, then the acknowledgment processor component 220 causes the sender computing device 102 to retransmit the data packet not received by the recipient computing device 104. Again, this treatment of duplicate acknowledgments falls outside of the standard corresponding to TCP (as the threshold number of duplicate acknowledgments utilized in TCP for retransmitting a data packet is three), and thus one or more computing devices (including network infrastructure devices) in the data center may require alteration outside of the TCP standard to treat duplicate acknowledgments in this fashion. Again, this approach is practical for situations where a single entity has ownership/control over each computing device (including network infrastructure device) in the data center.

While the system 200 has been illustrated and described as having certain components as being included in particular computing devices/apparatuses, it is to be understood that other implementations are contemplated by the inventors and are intended to fall under the scope of the hereto-appended claims. For example, the network infrastructure device 210 may include the acknowledgment generator component 218, and/or the recipient computing device 104 itself may be a switch, router, or the like. Additionally, the sender computing device 102 may comprise the entropy generator component. Further, the computing apparatus 202 may comprise the acknowledgement processor component 220.

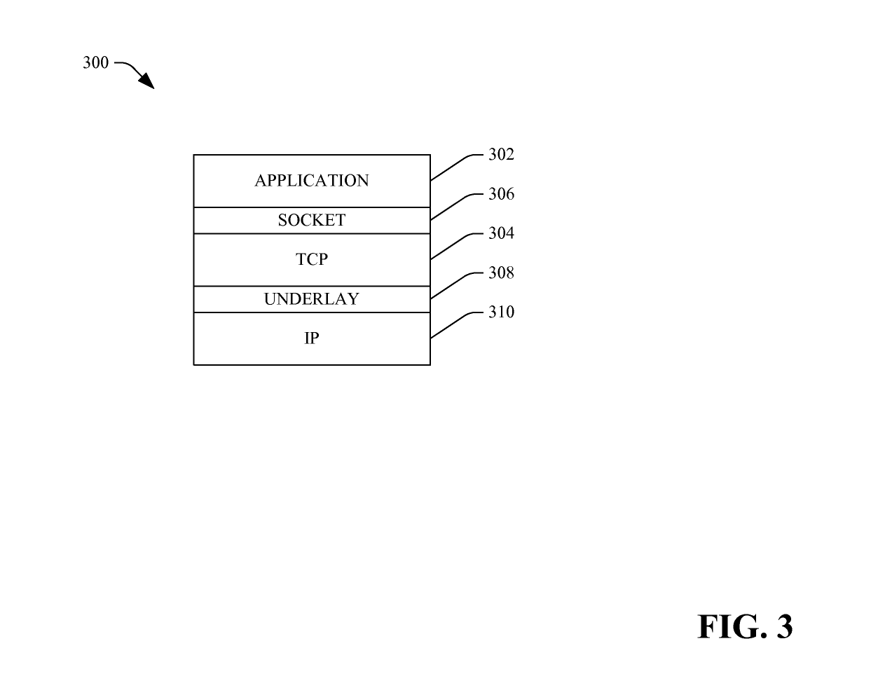

Now referring to FIG. 3, an exemplary implementation 300 of a TCP underlay is illustrated. In this example, an application 302 executing on a computing device is interfaces with the TCP protocol stack 304 by way of a socket 306. An underlay 308 lies beneath the TCP protocol stack 304, such that the TCP protocol stack 304 need not be modified. The underlay 308 can recognize duplicate acknowledgments and cause them to be thrown out/ignored, thereby allowing the TCP protocol stack 304 to remain unmodified. Additionally, the IP protocol stack 310 is unmodified.

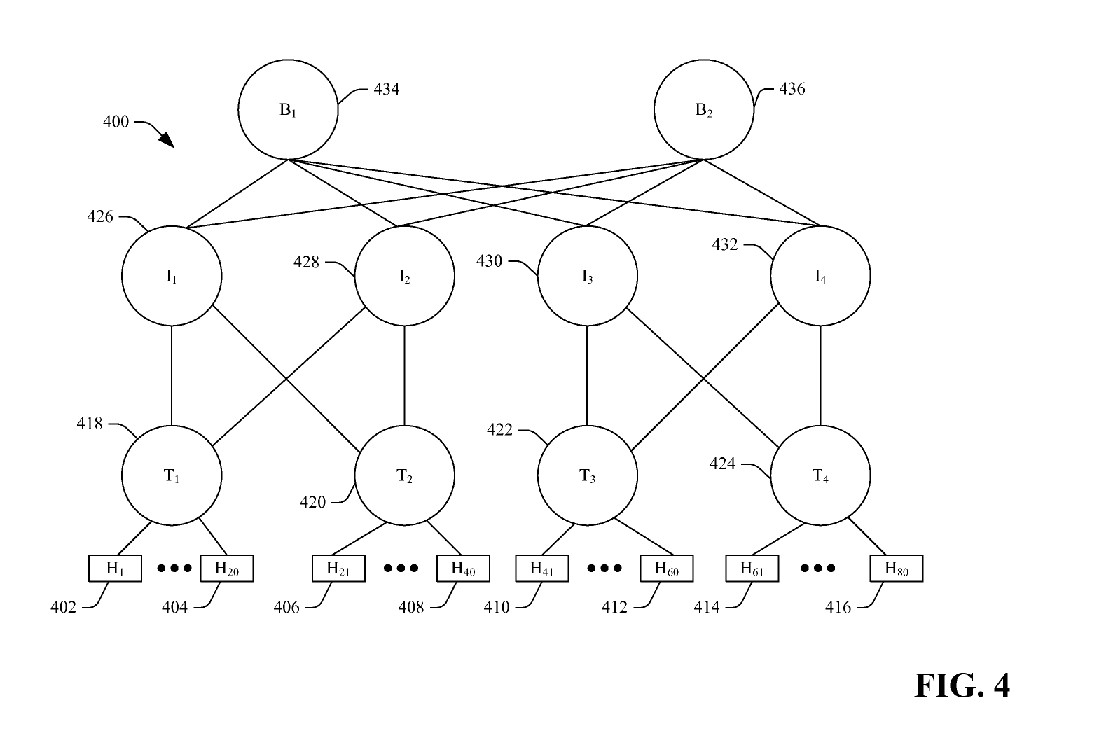

With reference now to FIG. 4, an exemplary data center structure 400 is illustrated. The data center structure 400 comprises a plurality of processing devices 402-416, which, for example, can be servers. These processing devices are denoted with the letter “H” as shown in FIG. 4. Particular groupings of processing devices (e.g., 402-404, 406-408, 410-412, and 414-416) can be in communication with a respective top-rack router (T-router). Thus, processing devices 402-404 are in direct communication with T-router 418, processing devices 406-408 are in direct communication with T-router 420, processing devices 410-412 are in direct communication with T-router 422, and processing devices 414-416 are in direct communication with T-router 424. While each T-router is shown to be in communication with twenty processing devices, a number of ports on the T-routers can vary and is not limited to twenty.

The data center structure 400 further comprises intermediate routers (I-routers) 426-432. Subsets of the I-routers 426-432 can be placed in communication with subsets of the T-routers 418-420 to conceptually generate an I-T bipartite graph, which can be separated into several sub-graphs, each of which are fully connected (in the sense of the bipartite graph). A plurality of bottom rack routers (B-routers) 434-436 can be coupled to each of the I-routers 426-432.

While the structure shown here is relatively simple, such structure can be expanded upon for utilization in a data center. Pursuant to an example, the displayed three-layer symmetric structure (group structure) that includes T-routers, I-routers, and B-routers, can be built based upon a 4-tubple system of parameters (D_{T}, D_{I}, D_{B}, N_{B}). D_{T}, D_{I}, and D_{B} can be degrees (e.g., available number of Network Interface Controllers) of a T-router, I-router, and B-router, respectively, and can be independent parameters. N_{B} can be the number of B-routers in the data center, and is not entirely independent, as N_{B}≦D_{I}−1 (each I-router is to be connected to at least one T-router). Several other structural property values that can be represented by this 4-tuple are shown below in list form:

A total number of I-routers N₁=D_{B}.

A number of T-routers connected to each I-router n_{T}=D_{I}−N_{B}, which can also be a number of T-routers in each first-level (T-I level) full-mesh bipartite graph.

A total number of T-routers

$${N}_{T} = \frac{{N}_{I} ( {D}_{I} - {D}_{B} )}{{D}_{T}} = \frac{{D}_{B} ( {D}_{I} - {N}_{B} )}{{D}_{T}} .$$

A total number of available paths for one flow nₚ=D_{T}²×N_{B}.

The dimension of each T-I bipartite graph and I-B bipartite graph can be (D_{I}−N_{B})×D_{T} and D_{B}×N_{B}, respectively, where both are full mesh.

A total number of T-I bipartite graphs can be equal to

$$\frac{{D}_{B}}{{D}_{T}} .$$

It can be noted that due to integer constraints, D_{B} can be a multiple of D_{T}.

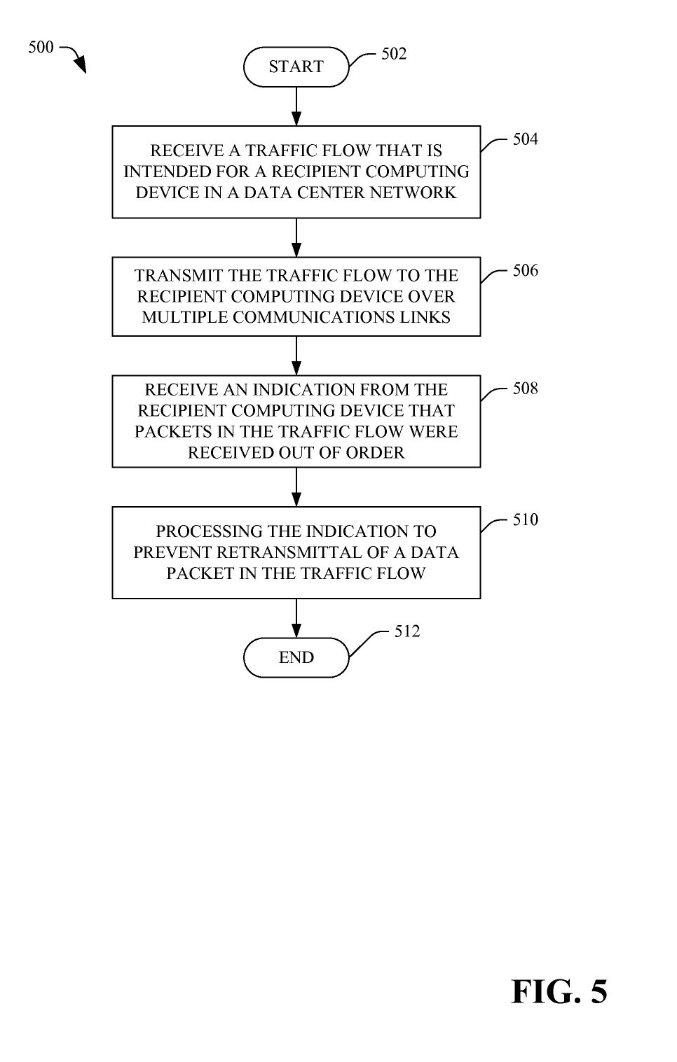

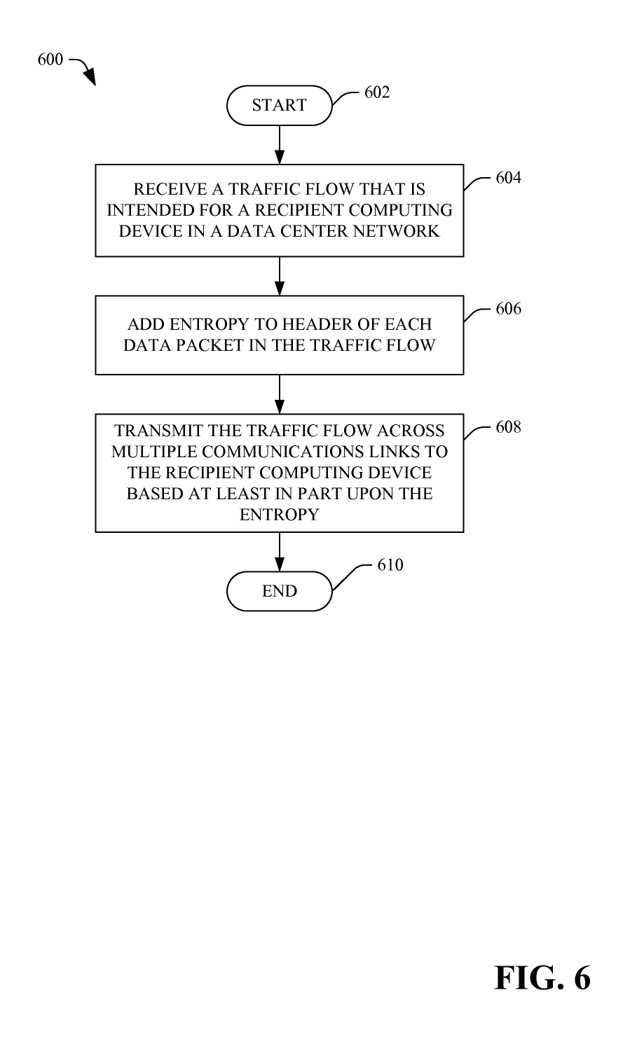

With reference now to FIGS. 5-6, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

Referring now to FIG. 5, a methodology 500 that facilitates transmitting a traffic flow over multiple communication paths in a data center network is illustrated. The methodology 500 begins at 502, and at 504 a traffic flow that is intended for a recipient computing device in a data center network is received. For instance, the traffic flow can be received at a switch or router, and the traffic flow can comprise a plurality of data packets that are desirably transmitted and received in a particular sequence.

At 506, the traffic flow is transmitted to the recipient computing device over multiple communications links. In an example, the recipient computing device can be a network switch or router. In another example, the recipient computing device can be a server.

At 508, an indication is received from the recipient computing device that data packets in the traffic flow were received outside of the particular sequence. As described above, this is possible, as data packets are transmitted over differing communication paths that may have differing latencies corresponding thereto. Pursuant to an example, the aforementioned indication may be a duplicate acknowledgment that is generated and transmitted in accordance with the TCP standard.

At 510, the indication is processed to prevent re-transmittal of a data packet in the traffic flow from the sender computing device to the recipient computing device. For instance, a software overlay can be employed to recognize the indication and discard such indication. In another example, the indication can be a duplicate acknowledgment, and can be treated as an initial acknowledgment in accordance with the TCP standard. In yet another example, a number of duplicate acknowledgments received with respect to a particular data packet can be counted, and the resultant number can be compared with a threshold that is greater than the threshold utilized in the TCP standard. The methodology 500 completes at 512.

With reference now to FIG. 6, an exemplary methodology 600 that facilitates transmitting a traffic flow over multiple communications paths in a data center. The methodology 600 starts at 602, and at 604 data that is intended for a recipient computing device in a data center network is received. For example, the data can be received from an application executing on a server in the data center, and a switch can be configured to partition such data into a plurality of data packets that are desirably transmitted and received in a particular sequence in accordance with the TCP standard.

At 606, entropy is added to the header of each data packet in the traffic flow. For instance, a hashing algorithm can be employed to alter insignificant bits in the address of an intended recipient computing device. This can cause the switch to transmit data packets in the traffic flow over different communications paths.

At 608, the traffic flow is transmitted across multiple communications links to the recipient computing device based at least in part upon the entropy added at act 606. The recipient computing device can include a hashing algorithm that acts to remove the entropy in the data packets, such that the traffic flow can be reconstructed and resulting data can be provided to an intended recipient application. The methodology 600 completes at 610.

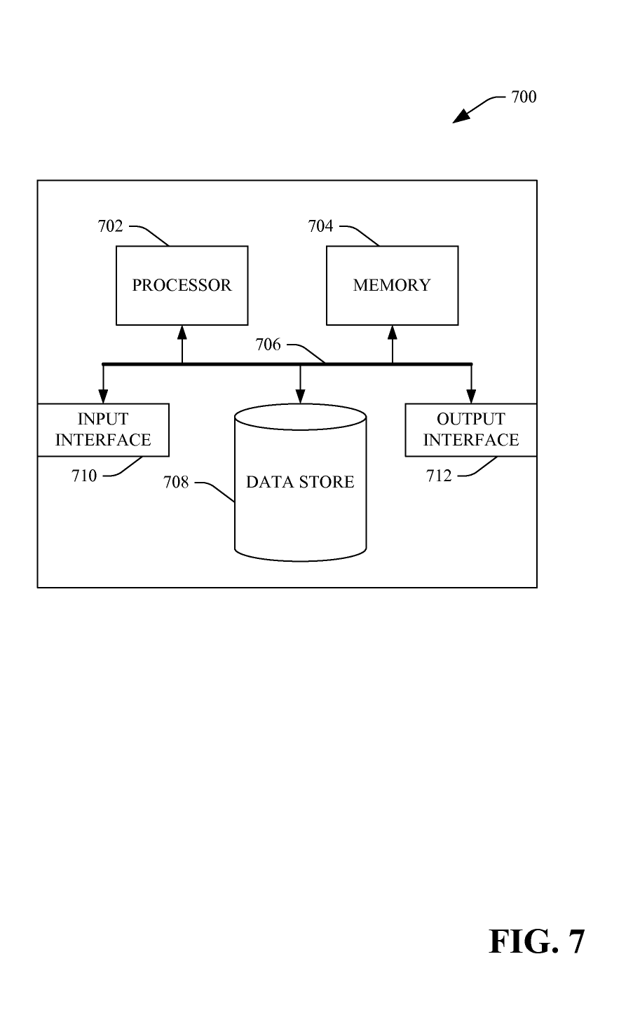

Now referring to FIG. 7, a high-level illustration of an exemplary computing device 700 that can be used in accordance with the systems and methodologies disclosed herein is illustrated. For instance, the computing device 700 may be used in a system that supports multi-patch communications of traffic flows in a data center. In another example, at least a portion of the computing device 700 may be used in a system that supports multi-path communications of traffic flows in WANs or LANs. The computing device 700 includes at least one processor 702 that executes instructions that are stored in a memory 704. The memory 704 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store a portion of a traffic flow, all or portions of a TCP network stack, etc.

The computing device 700 additionally includes a data store 708 that is accessible by the processor 702 by way of the system bus 706. The data store may be or include any suitable computer-readable storage, including a hard disk, memory, etc. The data store 708 may include executable instructions, a traffic flow, etc. The computing device 700 also includes an input interface 710 that allows external devices to communicate with the computing device 700. For instance, the input interface 710 may be used to receive instructions from an external computer device, from a network infrastructure device, etc. The computing device 700 also includes an output interface 712 that interfaces the computing device 700 with one or more external devices. For example, the computing device 700 may display text, images, etc. by way of the output interface 712.

Additionally, while illustrated as a single system, it is to be understood that the computing device 700 may be a distributed system. Thus, for instance, several devices may be in communication by way of a network connection and may collectively perform tasks described as being performed by the computing device 700.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method, comprising:
receiving, from a sender computing device in a data center, a traffic flow that is intended for a particular recipient computing device, wherein the traffic flow comprises a plurality of data packets that are desirably received by the recipient computing device in a certain sequence, wherein each of the plurality of data packets identify the particular recipient computing device, and wherein multiple communications paths are existent between the sender computing device and the recipient computing device;
selectively adding entropy to a header of each of the plurality of data packets in the traffic flow;
transmitting the network traffic flow over the multiple communications paths to the recipient computing device based at least in part upon the entropy added to the header of each of the plurality of data packets, wherein the recipient computing device receives a subset of the plurality of data packets outside of the certain sequence;
receiving from the recipient computing device an indication that the subset of the plurality of data packets was received outside of the certain sequence; and
processing the indication to prevent at least one data packet in the subset of the plurality of data packets from being retransmitted to the recipient computing device.

2. The method of claim 1, wherein the sender computing device and the recipient computing device are servers in the data center.

3. The method of claim 1, wherein a network switch is configured to perform the acts of receiving and transmitting.

4. The method of claim 1, wherein each of the communications paths has substantially similar bandwidth and latency.

5. The method of claim 1, wherein the sender computing device and the recipient computing device are configured to communicate with one another by way of the Transmission Control Protocol.

6. The method of claim 1, wherein the indication is a duplicate acknowledgment transmitted in accordance with the Transmission Control Protocol.

7. The method of claim 6, wherein processing the duplicate acknowledgement comprises:
incrementing a count upon receipt of the duplicate acknowledgment, wherein the count is incremented each time a duplicate acknowledgement corresponding to a particular data packet in the traffic flow is received;
comparing the count with a threshold value, wherein the threshold value is greater than three;
if the count is less than or equal to the threshold value, ignoring the duplicate acknowledgment; and
if the count is greater than the threshold value, retransmitting the data packet to the recipient computing device.

8. The method of claim 6, wherein processing the duplicate acknowledgment comprises:
recognizing the duplicate acknowledgment; and
selectively dropping the duplicate acknowledgment.

9. The method of claim 6, wherein processing the duplicate acknowledgment comprises:
recognizing the duplicate acknowledgment; and
selectively treating the duplicate acknowledgment as a regular acknowledgment in accordance with the Transmission Control Protocol.

10. The method of claim 1, wherein adding entropy comprises altering insignificant digits in an address field in headers of the data packets in the traffic flow.

11. The method of claim 1, wherein computing devices in the data center conform to a grouped topology.

12. The method of claim 1, wherein the processing is performed as an underlay below the TCP protocol.

13. An apparatus in a data center, comprising:
a receiver component that receives a traffic flow from a sender computing device that is desirably transmitted to a recipient computing device, wherein the traffic flow comprises a plurality of data packets, wherein each of the data packets comprises a header;
an entropy generator component that adds entropy to the header of each data packet; and
a transmitter component that transmits the traffic flow across a plurality of communications paths in the data center between the sender computing device and the recipient based at least in part upon the entropy added to the header of each data packet.

14. The apparatus of claim 13 being a network switch or router.

15. The apparatus of claim 13, wherein the sender computing device and the recipient computing device are configured to communicate with one another by way of the Transmission Control Protocol.

16. The apparatus of claim 13, further comprising:
an acknowledgment processor component that receives an indication from the recipient computing device that data packets in the traffic flow have been received outside of a desired sequence and processes the indication to prevent at least one data packet in the traffic flow from being retransmitted to the recipient computing device.

17. The apparatus of claim 16, wherein the indication is a duplicate acknowledgment with respect to a particular data packet transmitted to the apparatus in accordance with the Traffic Control Protocol, and wherein the acknowledgment processor component compares a number of duplicate acknowledgments with respect to the particular data packet to a threshold number and prevents retransmission of the particular data packet if the number of duplicate acknowledgments with respect to the particular data packet is below the threshold number, and wherein the threshold number is greater than three.

18. The apparatus of claim 16, wherein the indication is a duplicate acknowledgment with respect to a particular data packet transmitted to the apparatus in accordance with the Traffic Control Protocol, and wherein the acknowledgment processor component recognizes the duplicate acknowledgement and effectively drops the duplicate acknowledgment.

19. The apparatus of claim 16, wherein the indication is a duplicate acknowledgment with respect to a particular data packet transmitted to the apparatus in accordance with the Traffic Control Protocol, and wherein the acknowledgment processor component recognizes the duplicate acknowledgment and treats the duplicate acknowledgment as an indication that the particular packet was received but not as an indication that the particular data packet was received outside of the desired sequence.

20. A non-transitory computer-readable medium comprising instructions that, when executed by a processor, cause the processor to perform acts comprising:
in a data center with a topology that conforms to a group topology, transmitting a traffic flow to a recipient computing device over multiple communications paths in the data center network between a sender computing device and the recipient computing device, wherein the traffic flow comprises a plurality of data packets, and wherein a first data packet in the traffic flow is transmitted over a first communications path in the data center network to the recipient computing device and a second data packet in the traffic flow is transmitted over a second communications path in the data center network to the recipient computing device, wherein the first data packet is desirably received by the recipient computing device prior to the second data packet;
subsequent to transmitting the first data packet and the second data packet to the intended recipient computing device, receiving a duplicate acknowledgment from the intended recipient computing device in accordance with the Transmission Control Protocol with respect to the first data packet that indicates that the second data packet was received by the intended computing device prior to the first data packet; and
processing the duplicate acknowledgment such that the first data packet is prevented from being retransmitted to the intended recipient computing device.
